(19) United States
(12) Patent Application Publication
(10) Pub. No.: US 2009/0226116 A1
(43) Pub. Date: Sep. 10, 2009

(54) Dissolvable pouch

(75) Inventors: Stephen C. Hill, Perrysburg, OH (US); Theodore J. Russchen, Lorretto (CA)

Correspondence Address: EMCH, SCHAFFER, SCHAUB & PORCELLO CO, P O BOX 916, ONE SEAGATE SUITE 1980, TOLEDO, OH, 43697, US

(73) Assignee: CMC DayMark Corporation

(21) Appl. No.: 12/380,859

(22) Filed: Mar. 4, 2009

Related U.S. Application Data
(60) Provisional application No. 61/068,201, filed on Mar. 6, 2008.

(51) Int. Cl. B65D 30/02; B65D 30/08; B31B 1/62; B31B 49/04

(52) U.S. Cl. 383/1; 383/109; 493/264; 493/267

(57) ABSTRACT

A pouch for containing a product is formed of water dispersible or water dissolvable paper on the exterior and a water dissolvable adhesive on the interior. The method of manufacturing includes folding a sheet of paper about a central fold line such that adhesive applied thereto is on the interior and engages adhesive on the opposite side of the fold line. The adhesive adjacent the side edges is sealed to form seams at such side edges. After filling, the top edge may be sealed to form the completed pouch.

### CROSS REFERENCE TO PRIOR APPLICATION

This application is based upon and claims the benefit of U.S. provisional application No. 61/068,201 filed Mar. 6, 2008.

### BACKGROUND OF THE INVENTION

The present patent application is directed to a pouch manufactured utilizing water dissolvable or water dispersible paper and to a method for forming. It has long been known to package goods in water soluble pouches such as a film of polyvinyl alcohol (PVA). See for example U.S. Pat. No. 7,325,688.

### SUMMARY OF THE INVENTION

Under the present invention, there is provided a pouch manufactured of water soluble or water dispersible paper and to a method for forming such pouch. A typical application for the pouch of the present invention includes packaging of dyes or chemicals which are utilized as additives to change ph or color in batch processing. The pouch of the present invention, including the heat seal adhesive utilized therein, totally dissolves or is dispersed upon being added to and mixed with a batch of water-based material.

### BRIEF DESCRIPTION OF THE DRAWINGS

FIG. 1 is a sectional view of a laminate of water dissolvable paper and water dissolvable adhesive.

FIG. 2 is a plan view of the laminate of FIG. 1.

FIG. 3 is a view showing the laminate of FIG. 2 folded about its center line and with the two edges on opposite sides the center line being heat sealed thereby providing a partially formed pouch.

FIG. 4 is a view similar to FIG. 3 but showing a tube for dispensing a measured amount of contents into the partially formed pouch.

FIG. 5 is a view showing the filled and completely sealed pouch.

### DETAILED DESCRIPTION OF THE INVENTION

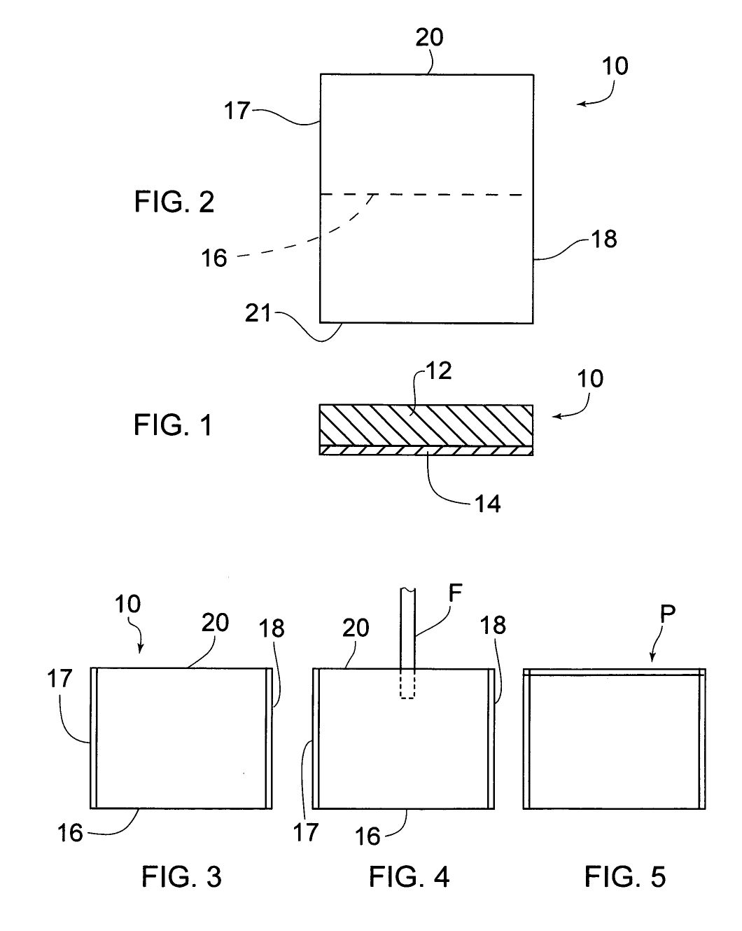

Referring to FIGS. 1 and 2, there is shown a laminate 10 comprising a sheet of water soluble paper 12 and a coating of water soluble adhesive 14. Shown in dashed lines in FIG. 2 and identified by the numeral 16 is the center line of the laminate 10 about which the laminate is to be folded in forming the final pouch P as shown in FIG. 5. The laminate 10 has side edges 17 and 18, an upper edge 20 and a lower edge 21 as viewed in FIG. 2

Water dispersible paper 12 maybe obtained from Hollingsworth & Vose Company, East Walpole, Mass. The water dissolvable adhesive 14 maybe obtained from Halltech, Inc., Toronto, Canada as its Item No. Thermseal 5A1-213M (V6). As a matter of efficiency, in applying the water dissolvable adhesive 14, the entire surface of the water dissolvable paper 12 is covered with such adhesive 14; however, it is within the contemplation of the scope of the present invention that the pouch could be formed equally well if only the portions of the paper 12 adjacent the edges received such adhesive as it is only the portions adjacent such edges which become sealed as maybe seen in FIG. 5. The dissolvable adhesive 14 is a type which must be heat activated.

In order to form the pouch of the present invention, the sheet laminate 10 is initially folded about the center line 16 and the upper half of such laminate 10 is brought into contact with the lower half. Thus, the upper portion of edge 17 is brought into contact with the lower portion of edge 17 and the upper portion of edge 18 is brought into contact with the lower portion of edge 18. Thus the paper 12 forms an exterior layer with the adhesive on the interior.

With the laminate 10 so folded, a heat seal device is heated to a temperature of 127° C. (plus or minus 10%) and is applied to the respective side edges 17 and 18 for approximately 1.2 seconds in order to seal the adjoined upper portion and lower portion of edge 17 and upper portion and lower portion of edge 18 to one another thereby forming a partially formed bag which is closed at the bottom center fold 16 and sealed at such edges 17 and 18. Preferably the width of the seal extends inwardly from the respective edges 17 and 18 a distance of 1/16 inch to ⅜ inch. The top edge 20 is not sealed to its adjacent edge which, prior to folding, was the bottom edge 21; therefore, the partially formed bag is open at the top edge 20. The exterior of the partially formed bag is water dispersible paper 12. The water dissolvable layer of adhesive 14 is inwardly of the paper 12 covering at least the portions adjacent edges 17 and 18 and one or both of the top edge 20 and the bottom edge 21 but preferably covering the entire surface.

As shown in FIG. 4, a fill tube F may then be inserted into the open upper end 20 to dispense a measured quantity of product into the partially formed pouch. Thereafter, the upper edge 20 in contact with the previously disposed lower edge 21 may then be engaged by a heated sealing bar heated to a temperature of 142° C. (plus or minus 10%) for a period of 1.2 seconds to thereby form the filled and sealed pouch P as shown in FIG. 5.

The above detailed description of the present invention is given for explanatory purposes. It will be apparent to those skilled in the art that numerous changes and modifications can be made without departing from the scope of the invention.

We claim:

1. A pouch for containing a product comprising a layer of water dissolvable or water dispersible paper and a layer of water dissolvable adhesive, said paper being folded upon itself to define (a) an exterior of paper having top and bottom edges and a pair of side edges, said bottom edge defining a fold line with first and second plies of paper extending from said fold line to said top edge; and, (b) an interior at least partly covered with adhesive including at said pair of side edges and said top edge; the adhesive at each of said side edges adhering together said first and second plies of paper adjacent thereto.

2. A pouch according to claim 1 wherein said interior is completely covered with said adhesive but only those portions of adhesive adjacent said side edges adhere said first and second plies of paper together.

3. A pouch according to claim 1 wherein the adhesive adjacent said top edge adheres said first and second plies of paper together in that area.

4. A pouch according to claim 1 wherein said interior is completely covered with said adhesive but only those portions of adhesive adjacent said side edges and said top edge adhere said first and second plies of paper together.

5. A pouch according to claim 1 wherein only those portions of said interior adjacent said sides edges and said top edge are covered with said adhesive.

6. A pouch according to claim 5 wherein the adhesive adjacent said side edges adheres said first and second plies together in those areas.

7. A pouch according to claim 6 wherein the adhesive adjacent said top edge adheres said first and second plies together in that area.

8. A method for forming a pouch having first and second plies for containing a product therebetween the steps of:
(a) applying water dissolvable adhesive to a sheet of water dissolvable or water dispersible paper, said paper having a pair of side edges, an upper edge for defining the top edge of one of said plies and a lower edge for defining the top edge of the other of said plies; said adhesive being applied at least to those areas of said sheet adjacent said side edges, said upper edge and said lower edge;
(b) folding said sheet about a central area to bring said upper and lower edges into engagement to thereby define a top edge of said pouch and thereby causing the portions of each of said side edges on one side of said central area to each engage its respective side edge on the other side of said central area and thereby bring the adhesive on one side of said central area into engagement with the adhesive on the other side of said central area; and
(c) causing the engaged adhesive adjacent said side edges to become adhered to thereby form a seal along each said side edge.

9. The method according to claim 8 further including the step of causing said adhesive to be applied to the entire surface of said paper and preventing said engaged adhesive from become adhered except in the areas adjacent said side edges.

10. The method according to claim 8 further including the steps of filling said pouch at said top edge and thereafter causing the adhesive adjacent thereto to become adhered to thereby form a seal along said top edge.
